(19) United States
(12) Patent Application Publication
(10) Pub. No.: US 2003/0139159 A1
(43) Pub. Date: Jul. 24, 2003

(54) Protective circuit and radio frequency device using the same

(75) Inventor: Yun Young, Takatsuki-shi (JP)

Correspondence Address: NIXON PEABODY, LLP, 8180 GREENSBORO DRIVE, SUITE 800, MCLEAN, VA, 22102, US

(73) Assignee: Matsushita Electric Industrial Co., Ltd., Osaka (JP)

(21) Appl. No.: 10/339,605

(22) Filed: Jan. 10, 2003

(30) Foreign Application Priority Data
Jan. 11, 2002 (JP) 2002-004384

(51) Int. Cl. H04B 1/16

(52) U.S. Cl. 455/217; 455/334

(57) ABSTRACT

An RF device has a substrate, a field effect transistor formed on the principal surface of the substrate, a grounded conductor film formed on the back surface of the substrate opposite to the principal surface, and a protective circuit formed between the gate of the field effect transistor and the grounded conductor film. The protective circuit is composed of an inductor or an inductor and a capacitor connected in parallel to each other.

### BACKGROUND OF THE INVENTION

The present invention relates to a radio frequency (RF) device and, more particularly, to an RF device comprising a circuit for preventing an electrostatic breakdown and a circuit for impedance matching.

As field effect transistors (FETs) used in RF devices, a Metal-Semiconductor FET (MESFET) containing a gallium arsenide (GaAs) as a main component and a high electron mobility transistor (HEMT) have been used widely. In particular, a monolithic microwave integrated circuit (MMIC) fabricated by integrating active and passive elements on a semi-insulating substrate made of GaAs is excellent in mass producibility and performance uniformity.

However, each of the MESFET and HEMT is not high in gate breakdown voltage since a gate composed of a Schottky junction is used therein. For example, static electricity resulting from human hand contact or a mechanical pulse signal produced upon the turning ON or OFF of a power supply may cause an electrostatic breakdown at the gate. In particular, a MESFET for use in a millimeter-wave band is likely to suffer the aforementioned electrostatic breakdown resulting from a pulsative surge such as static electricity or a mechanical pulse as described above since the MESFET is formed to have a gate length of about 0.1 μm to 1 μm.

As an example of conventional means for preventing an electrostatic breakdown, Japanese Laid-Open Patent Publication No. SHO 62-165977 discloses an RF device having a protective circuit composed of two diode elements which are oriented in opposite directions and connected in parallel.

As a conventional embodiment, the foregoing protective circuit composed of the two diode elements connected in an antiparallel configuration will be described herein below.

FIG. 9 shows a circuit structure of the RF device according to the conventional embodiment. As shown in FIG. 9, the conventional RF device has a FET 101 having a gate connected to an input terminal 102 via an input matching circuit 111, a drain connected to an output terminal 105 via an output matching circuit 112, and a source grounded. A protective circuit 113 composed of two diode elements 106 and 107 connected in an antiparallel configuration are connected to the input terminal 102. The protective circuit 113 has one common terminal connected to the input terminal 102 and the other common terminal grounded. The FET 101 has a gate connected to a gate power supply terminal 103 via a gate bias circuit 114 and the drain connected to a drain power supply terminal 104 via a drain bias circuit 115.

If a surge of positive charge flows into the input terminal 102, the diode element 106 connected in a forward direction when viewed from the input terminal 102 is turned ON and the surge flows to a ground terminal. If a surge of negative charge flows into the input terminal 102, the diode element 107 connected in a reverse direction when viewed from the input terminal 102 is turned ON so that the surge flows to the ground terminal. The gate of the FET 101 is thus protected from the surges.

However each of the diode elements 106 and 107 used in the protective circuit 113 of the conventional RF device causes a deviation from impedance matching on the input side for an RF signal. This causes the problem that a power loss produced in the RF signal inputted to the input terminal 102 is increased to reduce the power gain of the RF circuit.

Specifically, a parasitic impedance component composed of a parasitic capacitance and a parasitic resistance is produced in each of the diode elements 106 and 107. The parasitic impedance component deviates the impedance on the input side of the FET 101 from a design value. Since the parasitic impedance component is produced by intricate factors including variations in fabrication process and a structure of a component, the value of the parasitic impedance component is difficult to control.

Since each of the diode elements 106 and 107 has its parasitic capacitance and resistance values varying with a bias applied thereto, an amount of deviation from impedance matching varies if a voltage value differs, even though the characteristic values of the parasitic components of each of the diode elements 106 and 107 are specified. If the RF signal inputted to the input terminal 102 has a large amplitude, the value of the parasitic impedance component of each of the diode elements 106 and 107 varies significantly. In short, the input impedance deviates from a design value during the operation of the RF circuit so that the RF characteristic of the RF circuit deteriorates without providing a sufficient power gain.

### SUMMARY OF THE INVENTION

It is therefore an object of the present invention to solve the conventional problem and thereby provide a protective circuit for preventing an electrostatic breakdown resulting from a surge without causing a gain reduction.

To attain the object, a first protective circuit according to the present invention comprises: an inductor disposed in a line for transmitting an RF signal, the inductor having one terminal connected to the line and the other terminal grounded.

In the first protective circuit according to the present invention, a parasitic capacitance and a parasitic resistance are prevented from varying depending on the voltage value of an RF signal inputted from the line or a surge that has flown in from the outside. This allows the impedance of the protective circuit to be set to a specified value by means of an inductor so that the protective circuit is provided without causing a deviation from impedance matching.

Preferably, the first protective circuit according to the present invention is formed on a principal surface of a substrate having a grounded conductor film formed on a back surface thereof opposite to the principal surface and a through hole extending between the principal surface and the back surface, the first protective circuit being connected electrically to the grounded conductor film through the through hole. The arrangement ensures the connection between the line and the grounded conductor film and thereby allows a surge or an RF signal in an undesired frequency band that has flown into the line to flow to the ground.

In the first protective circuit according to the present invention, the inductor is preferably composed of a conductor line formed on the substrate. The arrangement allows the inductance value of the inductor to be controlled easily and reliably by changing the length of the conductor line.

In the first protective circuit according to the present invention, the conductor line is preferably composed of a single-layer film made of gold or a multilayer film made of platinum and titanium stacked successively in layers.

A second protective circuit according to the present invention comprises: an inductor and a capacitor each disposed in a line for transmitting an RF signal, the inductor and the capacitor being connected in parallel to each other and having one common terminal connected to the line and the other common terminal grounded.

In the second protective circuit according to the present invention, a parasitic capacitance and a parasitic resistance are prevented from varying depending on the voltage value of an RF signal inputted from a line or a surge that has flown in from the outside.

Preferably, the second protective circuit according to the present invention is formed on a principal surface of a substrate having a grounded conductor film formed on a back surface thereof opposite to the principal surface and a through hole extending between the principal surface and the back surface, the protective circuit being connected electrically to the grounded conductor film through the through hole.

In the second protective circuit according to the present invention, the inductor is preferably composed of a conductor line formed on the substrate.

In the second protective circuit according to the present invention, the conductor line is preferably composed of a single-layer film made of gold or a multilayer film made of platinum and titanium stacked successively in layers.

In the second protective circuit according to the present invention, the capacitor is preferably composed of an insulating film and upper and lower metal films having the insulating film interposed therebetween.

In the second protective circuit according to the present invention, each of the metal films is preferably a single-layer film made of gold or a multilayer film made of platinum and titanium stacked successively in layers.

In the second protective circuit according to the present invention, the insulating film is preferably made of a silicon nitride.

A first RF device according to the present invention comprises: a substrate; a field effect transistor formed on a principal surface of the substrate; a grounded conductor film formed on a back surface of the substrate opposite to the principal surface; and a protective circuit for providing an electric connection between a gate of the field effect transistor and the grounded conductor film.

In the first RF device according to the present invention, even if a surge flows into the RF device, the surge is allowed to flow to the ground via the protective circuit so that the gate is protected from the surge. Since the impedance of the protective circuit does not vary depending on an RF signal inputted to the gate or a surge that has flown in from the outside, the protective circuit is allowed to function as a part of the input-side impedance converting circuit so that the protective circuit is provided without causing the degradation of the RF characteristic.

In the first RF device according to the present invention, the protective circuit is preferably provided to match an input impedance of the field effect transistor. Even if the protective circuit is provided, a deviation from impedance matching does not occur in the arrangement and the structure of the impedance converting circuit can be simplified.

In the first RF device according to the present invention, the substrate preferably has a through hole extending between the principal surface and back surface thereof and the protective circuit is preferably composed of a conductor film formed on the principal surface of the substrate and having a portion on a wall surface of the through hole connected to the grounded conductor film. The arrangement ensures the connection between the gate of the field effect transistor and the grounded conductor film.

In the first RF device according to the present invention, the conductor film preferably has a line portion formed on the principal surface of the substrate. The arrangement allows the impedance of the protective circuit to be controlled easily and reliably by changing the length of the line portion.

In the first RF device according to the present invention, an element composing the protective circuit and the field effect transistor are preferably formed monolithically on the substrate. The arrangement provides an RF device excellent in mass producibility and performance uniformity.

In the first RF device according to the present invention, the substrate is preferably composed of a compound semiconductor and the field effect transistor is preferably of Schottky junction type.

A second RF device according to the present invention comprises: a substrate; a field effect transistor formed on a principal surface of the substrate; a grounded conductor film formed on a back surface of the substrate opposite to the principal surface; and a protective circuit for providing an electric connection between a drain of the field effect transistor and the grounded conductor film.

In the second RF device according to the present invention, even if a surge flows into the RF device, the surge is allowed to flow to the ground via the protective circuit so that the drain is protected from the surge. Since the impedance of the protective circuit does not vary depending on an RF signal outputted from the drain or a surge that has flown in from the outside, the protective circuit is allowed to function as a part of the output-side impedance converting circuit so that the protective circuit is provided without the degradation of the RF characteristic.

In the second RF device according to the present invention, the protective circuit is preferably provided to match an output impedance of the field effect transistor.

In the second RF device according to the present invention, the substrate preferably has a through hole extending between the principal surface and back surface thereof and the protective circuit is preferably composed of a conductor film formed on the principal surface of the substrate and having a portion on a wall surface of the through hole connected to the grounded conductor film.

In the second RF device according to the present invention, the conductor film preferably has a line portion formed on the principal surface of the substrate.

In the second RF device according to the present invention, an element composing the protective circuit and the field effect transistor are preferably formed monolithically on the substrate.

In the second RF device according to the present invention, the substrate is preferably composed of a compound semiconductor and the field effect transistor is preferably of Schottky junction type.

A third RF device according to the present invention comprises: a field effect transistor to which an RF signal is inputted; and a protective circuit composed of an inductor and a capacitor connected in parallel to each other and having one common terminal connected to a gate of the field effect transistor and the other common terminal grounded, the protective circuit being in a state open to a frequency of the RF signal.

In the third RF device according to the present invention, the RF signal can be inputted to the gate with no loss. Since the impedance of the protective circuit does not vary depending on the voltage values of the RF signal and the surge, the RF characteristic does not deteriorate.

In the third RF device according to the present invention, the protective circuit is preferably formed on a principal surface of a substrate having a grounded conductor film formed on a back surface thereof opposite to the principal surface and a through hole extending between the principal surface and the back surface and the grounded common terminal of the protective circuit is preferably connected electrically to the grounded conductor film through the through hole. The arrangement provides a connection between the field effect transistor and the grounded conductor film so that the field effect transistor is protected reliably from a surge that has flown in from the outside.

Preferably, the third RF device according to the present invention further comprises: a bias circuit composed of a capacitor and a resistor connected in parallel to each other and having one common terminal connected to a source of the field effect transistor and the other common terminal grounded. The arrangement allows control of the bias voltage applied to the gate and thereby reduces a current consumed in the RF device.

In the third RF device according to the present invention, the protective circuit and the bias circuit are preferably formed on a substrate having a grounded conductor film formed on a back surface of the substrate opposite to a principal surface thereof and a plurality of through holes extending between the principal surface and the back surface and each of the grounded common terminals of the protective circuit and the bias circuit is preferably connected electrically to the grounded conductor film through one of the plurality of through holes.

In the third RF device according to the present invention, the substrate is preferably composed of a compound semiconductor and the field effect transistor is preferably of Schottky junction type.

In the third RF device according to the present invention, an element composing the protective circuit and the field effect transistor are preferably formed monolithically on the substrate.

A fourth RF device according to the present invention comprises: a field effect transistor to which an RF signal is inputted; and a protective circuit composed of an inductor and a capacitor connected in parallel to each other and having one common terminal connected to a drain of the field effect transistor and the other common terminal grounded, the protective circuit being in a state open to a frequency of the RF signal.

In the fourth RF device according to the present invention, the RF signal can be outputted to the outside with no loss. Since the impedance of the protective circuit does not vary depending on the voltage values of the RF signal and the surge, the RF characteristic does not deteriorate.

In the fourth RF device according to the present invention, the protective circuit is preferably formed on a principal surface of a substrate having a grounded conductor film formed on a back surface thereof opposite to the principal surface and a through hole extending between the principal surface and the back surface and the grounded common terminal of the protective circuit is preferably connected electrically to the grounded conductor film through the through hole.

Preferably, the fourth RF device according to the present invention further comprises: a bias circuit composed of a capacitor and a resistor connected in parallel to each other and having one common terminal connected to a source of the field effect transistor and the other common terminal grounded.

In the fourth RF device according to the present invention, the protective circuit and the bias circuit are preferably formed on a substrate having a grounded conductor film formed on a back surface of the substrate opposite to a principal surface thereof and a plurality of through holes extending between the principal surface and the back surface and each of the grounded common terminals of the protective circuit and the bias circuit is preferably connected electrically to the grounded conductor film through one of the plurality of through holes.

In the fourth RF device according to the present invention, the substrate is preferably composed of a compound semiconductor and the field effect transistor is preferably of Schottky junction type.

In the fourth RF device according to the present invention, an element composing the protective circuit and the field effect transistor are preferably formed monolithically on the substrate.

### BRIEF DESCRIPTION OF THE DRAWINGS

FIG. 1 shows a circuit structure of an RF device according to a first embodiment of the present invention;

FIG. 2A shows a plan structure of the protective circuit of the RF device according to the first embodiment and FIG. 2B shows a cross-sectional structure taken along the line IIb-IIb of FIG. 2A;

FIG. 3 shows a circuit structure of an RF device according to a variation of the first embodiment;

FIG. 4 shows a circuit structure of an RF device according to a second embodiment of the present invention;

FIG. 5A is a plan view of the protective circuit according to the second embodiment, FIG. 5B is a cross-sectional view taken along the line Vb-Vb of FIG. 5A, FIG. 5C is a cross-sectional view showing a variation of grounding through holes, and FIG. 5D is a plan view showing a variation of a through hole for a capacitor;

FIG. 6 shows a circuit structure of a field effect transistor according to a first variation of the second embodiment;

FIG. 7 shows a circuit structure of a field effect transistor according to a second variation of the second embodiment;

FIG. 8 is a graph showing the relationship between the operating frequency and maximum power gain of the RF circuit according to the second embodiment; and

FIG. 9 shows a circuit structure of a conventional RF device.

### DETAILED DESCRIPTION OF THE INVENTION

### Embodiment 1

A first embodiment of the present invention will be described with reference to the drawings.

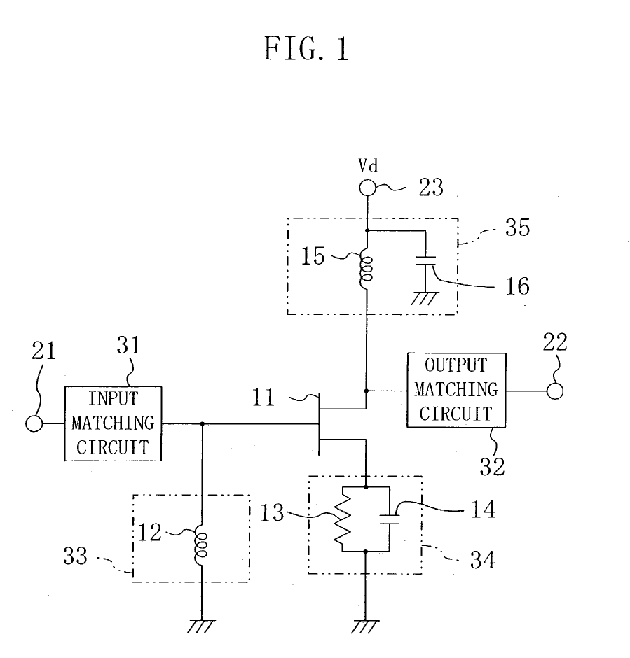

FIG. 1 shows a circuit structure of an RF device according to the first embodiment. As shown in FIG. 1, the RF device according to the first embodiment comprises: a FET 11; an input matching circuit 31 and an output matching circuit 32 each including one or more inductors or capacitors; a protective circuit 33 composed of a first inductor 12; a source bias circuit 34 composed of a resistor 13 and a first capacitor 14 connected in parallel to each other; and a drain bias circuit 35 composed of a second inductor 15 and a second capacitor 16.

The first inductor 12 has one terminal connected to the gate of the FET 11 and the other terminal grounded. The resistor 13 and the first capacitor 14 are connected in parallel and have one common terminal connected to the source of the FET 11 and the other common terminal grounded. The second inductor 15 has one terminal connected to a drain power supply terminal 23 and the other terminal connected to the drain of the FET 11. The second capacitor 16 has one electrode connected to the drain power supply terminal 23 and the other electrode grounded.

The gate of the FET 11 is connected to an input terminal 21 via the input matching circuit 31, while it is grounded via the protective circuit 33. The source of the FET 11 is grounded via the source bias circuit 34. The drain of the FET 11 is connected to the drain power supply terminal 23 via the drain bias circuit 35, while it is connected to an output terminal 22 via the output matching circuit 32.

Passive elements including a resistor, a capacitor, and an inductor composing each of the foregoing circuits, the FET 11, and metal lines for providing connections therebetween are formed monolithically on a principal surface of a substrate composed of GaAs. The FET 11 is formed as a GaAs-based MESFET or HEMT composed of a semiconductor layer in which GaAs-based compound semiconductors are stacked in layers, source and drain regions formed in the semiconductor layer, source and drain electrodes making ohmic contacts with the source and drain regions, respectively, and a gate electrode forming a Schottky junction with a channel region between the source and drain regions.

Each of the input matching circuit 31 and the output matching circuit 32 is an impedance converting circuit and having at least one more capacitors or inductors disposed therein. Specifically, the impedance of a circuit connected to the input side of the FET 11 is converted to match the input impedance of the FET 11 by inserting the input matching circuit 31. Likewise, the impedance of a circuit connected to the output side of the FET 11 is converted to match the output impedance of the FET 11 by inserting the output matching circuit 32.

The protective circuit 33 is composed of a first inductor 12 and the impedance thereof has been set to cut off a surge flowing into the input terminal 21 or a signal in an undesired frequency band for the FET 11.

On the input side of the FET 11, the protective circuit 33 and the input matching circuit 31 constitute an impedance converting circuit. Since the protective circuit 33 is provided as a part of the matching circuit to have an impedance which cuts off an RF signal in an undesired frequency band, impedance conversion in the input matching circuit 31 may be performed appropriately by considering the magnitude of the impedance of the protective circuit 33 so that the structure of the input matching circuit 31 is simpler than in the conventional embodiment.

The position at which the input matching circuit 31 is inserted is not limited to the space between the input terminal 21 and the protective circuit 33. The input matching circuit 31 may also be inserted between the protective circuit 33 and the gate. It is also possible to achieve impedance matching by using only the protective circuit 33.

The source bias circuit 34 controls a gate-to-source voltage. Since the gate is at a ground potential in the first embodiment, it is impossible to directly control the gate voltage but a voltage drop occurring in the source bias circuit 34 can be adjusted by varying the resistance value of the resistor 13 so that the operating point of the FET 11 is controlled. Here, the first capacitor 14 functions as an RF bypass capacitor for suppressing the influence of the resistor 13 on the RF signal. If it is unnecessary to control the gate-to-source voltage, the source bias circuit 34 need not be provided so that the source of the FET 11 is appropriately grounded directly.

The drain bias circuit 35 cuts off an undesired RF signal to the output terminal 22 by means of the second inductor 15 and outputs an amplified RF signal outputted from the drain of the FET 11 to the output terminal 22 via the output matching circuit 32. The RF component of the RF signal outputted from the drain which has passed the second inductor 15 is bypassed to the ground terminal via the second capacitor 16.

A description will be given herein below to a specific structure of the protective circuit 33 according to the first embodiment.

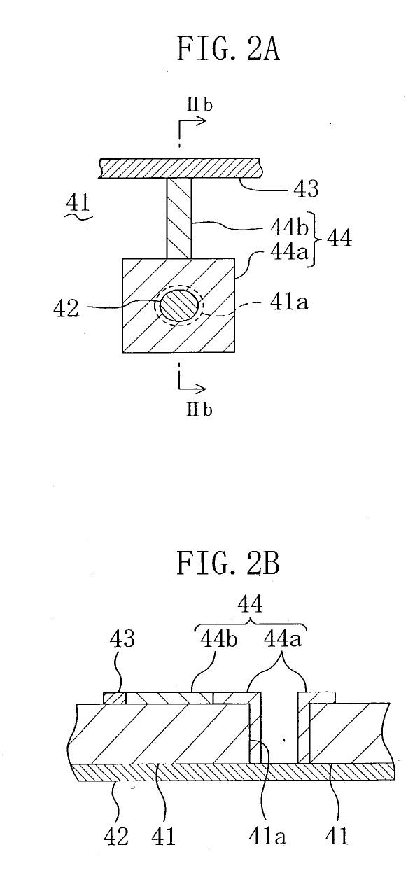

FIG. 2A shows a plan structure of the protective circuit in the RF device according to the present invention and FIG. 2B shows a cross-sectional structure taken along the line IIb-IIb of FIG. 2A.

As shown in FIGS. 2A and 2B, a grounding through hole 41a connecting the principal surface of a substrate 41 made of, e.g., GaAs to the back surface thereof opposite to the principal surface is formed in the substrate 41. A plate-like grounded conductor film 42 made of, e.g., gold (Au) is formed on the back surface of the substrate 41. The grounded conductor film 42 is supplied with a ground potential. A metal line 43 provides a connection between the input matching circuit 31 and the gate of the FET 11.

A connecting portion 44 is formed as a protective circuit formed to provide a connection between the gate of the FET 11 and the grounded conductor film 42. The connecting portion 44 is composed of a hole conductor film 44a made of Au formed over the wall surface of the grounding through hole 41a and an upper surface portion connected to the wall surface and a conductor line 44b made of Au formed on the principal surface of the substrate 41. The conductor line 44b has one end portion connected to a metal line 43 and the other end portion connected to the hole conductor film 44a. The hole conductor film 44a is connected to the grounded conductor film 42 on the back surface of the substrate 41.

A material composing the hole conductor film 44a and the conductor line 44b is not limited to Au. Each of the hole conductor film 44a and the conductor line 44b may also be formed as a multilayer film by successively stacking platinum and titanium in layers.

Since the connecting portion 44 is electrically short-circuited upon connection with the grounded conductor film 42, the connecting portion 44 functions as an inductor for an RF signal. Briefly, the connecting portion 44 functions as the first inductor 12 composing the protective circuit 33.

The inductance of the connecting portion 44 can be set to a specified value by changing, e.g., the length of the conductor line 44b. Specifically, the first embodiment has set the length of the conductor line 44b to about 50 μm to 500 μm since it uses the conductor line 44b as a matching element for an RF signal at a frequency in a quasi-millimeter band (about 20 GHz) or higher. This allows a surge and an undesired RF component to flow to the ground such that it is cut off from the FET 11.

It is also possible to set the inductance value of the connecting portion 44 by a method which changes the thickness of the substrate 41 or changes the configuration of the grounding through hole 41a. If a specified inductance value is obtainable only by, e.g., changing the thickness of the substrate 41, the provision of the conductor line 44b may be omitted by forming the hole conductor film 44a in contact relation with the metal line 43.

Referring to FIGS. 1, 2A, and 2B, a specific description will be given herein below to the operation of the RF device according to the first embodiment.

When an RF signal in a specified frequency band is inputted initially to the input terminal 21, the inputted RF signal is inputted to the FET 11 via the input matching circuit 31. By adjusting the length of the conductor line 44b to about 50 μm to 500 μm, the protective circuit 33 exhibits an extremely high impedance to the frequency band of the RF signal so that the RF signal is inputted to the FET 11 without flowing to the ground.

If a pulsative surge has flown into the input terminal 21, it flows to the ground through the protective circuit 33 since it is low in frequency than the RF signal. Specifically, static electricity generated from a human body (Human Body Model) is an electrostatic pulse in a frequency band of 2.1 MHz or less and a mechanical pulse signal (Machine Model) generated when the power supply is turned ON or OFF is an electrostatic pulse in a frequency band of 12 MHz or less so that the respective frequencies thereof are extremely low compared with the frequency of an RF signal in the quasi-millimeter band. The gate of the FET 11 can therefore be protected from electrostatic breakdowns caused by the surges.

The impedance of a circuit for inputting the RF signal to the input terminal 21 is converted to match the input impedance of the FET 11 by the input matching circuit 31 and the protective circuit 33. Specifically, the first inductor 12 of the protective circuit 33, i.e., the connecting portion 44 and the input matching circuit 31 constitute the impedance converting circuit. This minimizes a power loss in the input signal on the input side.

Since the gate of the FET 11 is grounded via the protective circuit 33, the voltage at the gate becomes the ground potential, e.g., 0 V However, a bias voltage can be applied to the source by means of the source bias circuit 34. The value of the bias voltage can be controlled by adjusting the resistance value of the resistor 13. A drain bias voltage Vd is applied from the drain power supply terminal 23 to the drain of the FET 11 via the drain bias circuit 35. As a result, the RF signal inputted to the gate is outputted from the drain as an RF signal amplified by the FET 11.

The RF signal outputted from the drain of the FET 11 is outputted to the output terminal 22 via the output matching circuit 32. The output impedance of the FET 11 is converted by the output matching circuit 32 to match the impedance of an external circuit connected to the output terminal 22 so that a power loss on the output side is minimized. Thus, in the RF device according to the first embodiment, a surge that has flown into the input terminal 21 is allowed to flow to the ground without reaching the gate of the FET 11 since the protective circuit 33 providing a connection between the gate of the FET 11 and the ground terminal is provided therein. Moreover, the protective circuit 33 can be introduced without causing a deviation from impedance matching since the protective circuit 33 is allowed to function as the impedance converting circuit in conjunction with the input matching circuit 31. As a result, a high-performance RF device can be obtained without degrading the RF characteristics thereof including a power gain.

It is also possible to scale down the RF device since there is no need to provide the protective circuit with a diode element that has been provided in the conventional RF device using the diode element so that the structure of the input matching circuit 31 is simplified.

### Variation of Embodiment 1

An RF device according to a variation of the first embodiment of the present invention will be described herein below with reference to the drawings.

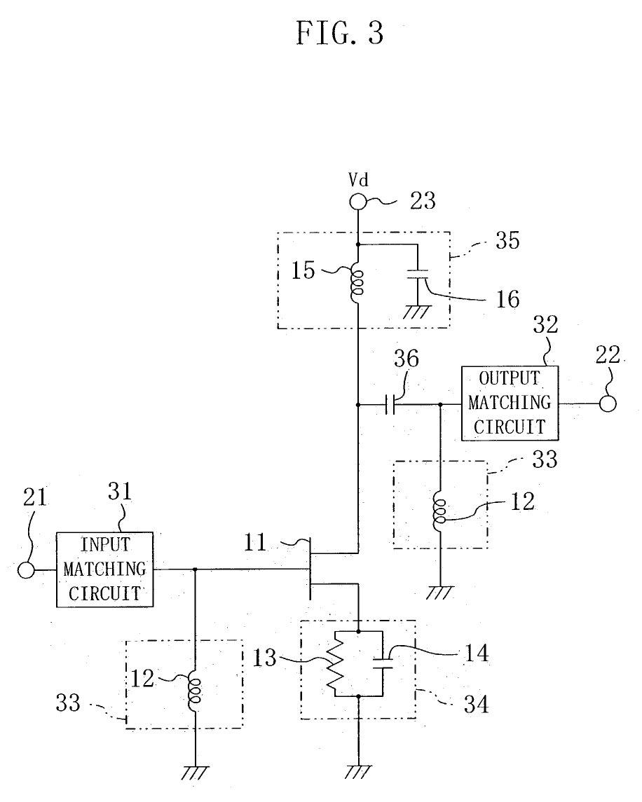

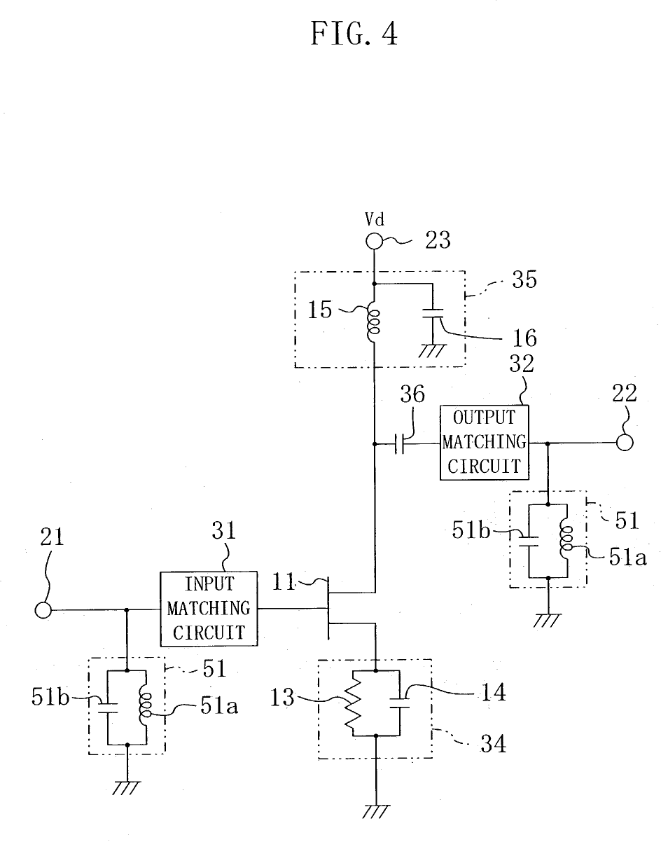

FIG. 3 shows a circuit structure of an RF device according the variation of the first embodiment. The description of the same components in FIG. 3 as in the first embodiment will be omitted by retaining the same reference numerals. In the RF device according to the present variation, the protective circuit 33 is provided at each of the gate and drain of a FET 11, as shown in FIG. 3.

A block capacitor 36 for cutting off a dc current is disposed between the drain of the FET 11 and the protective circuit 33. The block capacitor 36 prevents the drain voltage Vd from becoming a ground potential.

In the present variation, each of protective circuits 33 uses a connecting portion 44 composed of a hole conductor film 44a and a conductor line 44b as a first inductor 12, which is connected to a grounded conductor film 42 through a grounding through hole 41a.

The impedance of the protective circuit 33 connected to the drain has been set to cut off an undesired RF signal or a surge that has flown to an output terminal 22 for the FET 11. Specifically, the impedance of the protective circuit 33 is set by properly changing the length of the conductor line 44b or the thickness of a substrate and thereby adjusting the inductance value of the first inductor 12.

On the output side of the FET 11, the protective circuit 33 connected to the drain and an output matching circuit 32 constitute an impedance converting circuit. Since the protective circuit 33 connected to the drain has an impedance which cuts off a surge and an undesired RF signal to the FET 11, impedance conversion in the output matching circuit 32 may be performed appropriately by considering the magnitude of the impedance of the protective circuit 33 so that the structure of the output matching circuit 32 is simpler than in the conventional embodiment.

Although the present variation has provided the protective circuit 33 at each of the gate and drain of the FET 11, the protective circuit 33 connected to the gate need not necessarily be provided. The FET 11 can be protected from a surge flowing into the output terminal 22 by the protective circuit 33 connected to the drain.

In the present variation, the position at which the protective circuit 33 connected to the drain is inserted is not limited to the space between the drain and the output matching circuit 32. The protective circuit 33 may also be inserted between the output matching circuit 32 and the output terminal 22. In the case of achieving impedance matching by using only the protective circuit 33 connected to the drain, the output matching circuit 32 is no more necessary.

According to the variation of the first embodiment, a surge that has flown into the output terminal is allowed to flow to the ground without reaching the drain of the FET 11 and the protective circuit 33 can be disposed without causing a deviation from impedance matching on the output side. As a result, there can be provided a high-performance RF device free of a gain reduction even if it is used in the RF frequency band and excellent in surge resistance.

Since the inductance value of the first inductor 12 does not change even if a bias in the protective circuit 33 is changed by an RF signal with a large amplitude inputted to the input terminal 21 according to each of the first embodiment and the variation thereof, a deviation from impedance matching depending on a bias voltage does not occur.

If the protective circuit 33 is brought into a state open to an RF signal at the operating frequency in the RF device according to each of the first embodiment and the variation thereof, impedance matching can also be achieved by using only the input matching circuit 31 or only the output matching circuit 32 without considering the protective circuit 33.

Specifically, the length of the conductor line 44b composing the protective circuit 33 is adjusted preferably to correspond to an integral multiple of the quarter wavelength of the frequency of an RF signal inputted to the FET 11. This brings the protective circuit 33 into a state open to an RF signal at a specified frequency so that the specified RF signal is inputted to the FET 11 without flowing to the ground.

### Embodiment 2

A second embodiment of the present invention will be described with reference to the drawings.

FIG. 4 shows an RF device according to the second embodiment. The description of the same components in FIG. 3 as in the RF device shown in FIG. 1 will be omitted by retaining the same reference numerals.

As shown in FIG. 4, a FET 11 has a gate connected to an input terminal via an input matching circuit 31, a source grounded via a source bias circuit 34, a drain connected to an output terminal 22 via an output matching circuit 32, and a drain connected to the output terminal 22 via the output matching circuit 32 and also connected to a drain power supply terminal 23 via a drain bias circuit 35.

The input matching circuit 31 achieves impedance matching between the FET 11 and a circuit for inputting an RF signal to the input terminal. The output matching circuit 32 achieves impedance matching between the FET 11 and a circuit for receiving an amplified RF signal from the output terminal.

The source bias circuit 34 supplies a bias voltage between the gate and source of the FET 11. By adjusting the resistance value of a resistor 13, the source bias circuit 34 can supply a negative bias voltage even if a gate voltage is 0 V.

A block capacitor 36 for cutting off a dc current is disposed between the drain of the FET 11 and the output matching circuit 32.

The FET 11 and respective elements composing protective circuits 51, the input matching circuit 31, the output matching circuit 32, the source bias circuit 34, and the drain bias circuit 35 are formed monolithically on a substrate made of GaAs. For example, an inductor 51a composing each of the protective circuits 51 is implemented as a conductor line composed of a single-layer film made of gold or a multilayer film composed of platinum and titanium stacked successively in layers on the substrate, while a capacitor 51b is formed as a MIM (Metal-Insulator-Metal) capacitor composed of an insulating film and upper and lower metal films having the insulator film interposed therebetween. To compose the MIM capacitor, e.g., a single-layer film made of gold or a multilayer film composed of platinum and titanium stacked successively in layers can be used as each of the metal films and a silicon nitride film can be used as the insulating film.

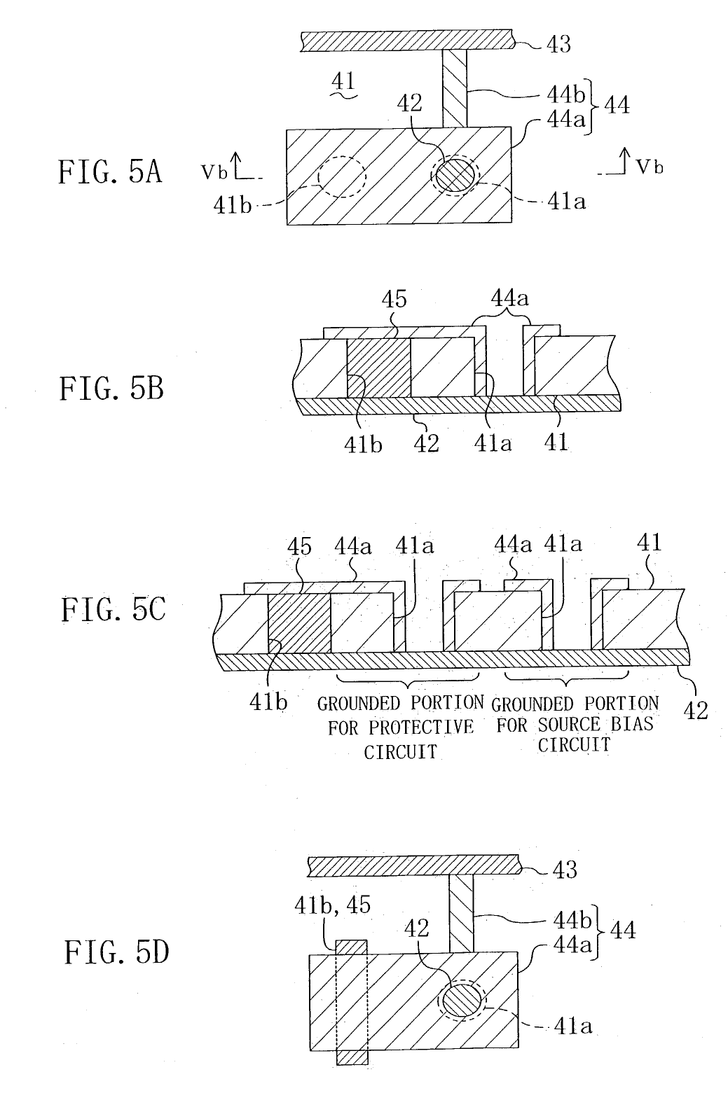

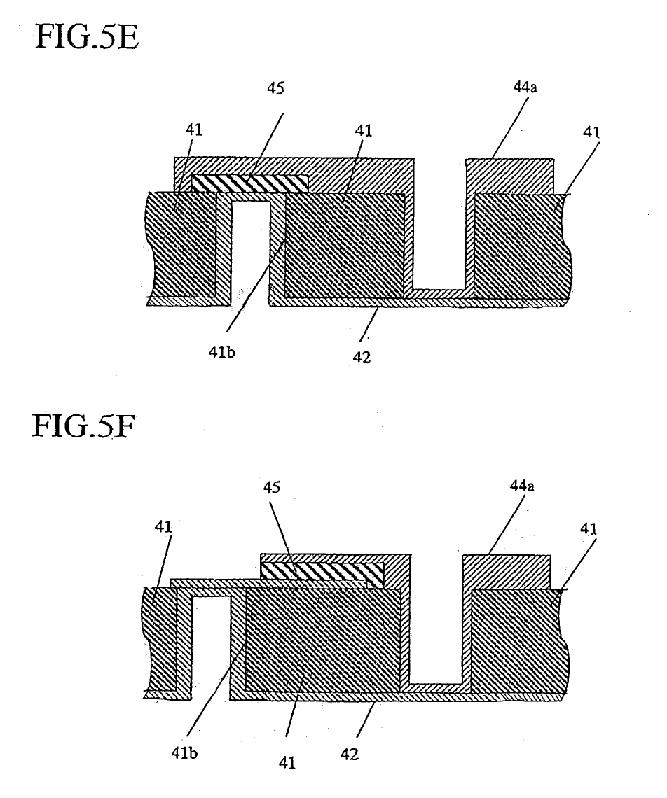

FIGS. 5A and 5B show a specific structure of the protective circuits 51, of which FIG. 5A shows a plan structure of the protective circuit 51 and FIG. 5B shows a cross-sectional structure taken along the line Vb-Vb of FIG. 5A.

As shown in FIGS. 5A and 5B, a grounding through hole 41a connecting the principal surface of a substrate 41 made of GaAs to the back surface thereof opposite to the principal surface and a through hole 41b for a capacitor are formed in the substrate 41. A grounded conductor film 42 made of, e.g., gold is formed on the back surface of the substrate 41.

A hole conductor film 44a serving as a pad portion for grounding is formed over the wall surface of the grounding through hole 41a and an upper surface portion connected to the wall surface. The hole conductor film 44a is connected, via a conductor line 44b extending from the hole conductor film 44a, to a metal line 43 providing a connection between an input terminal 21 and the input matching circuit 31.

A dielectric film 45 composed of a silicon nitride is filled in the through hole 41b for a capacitor. A hole conductor film 44a is formed to cover the dielectric film in the hole 41b for a capacitor.

The hole conductor film 44a and the conductor line 44b constitute the connecting portion 44 connected to the ground and also constitute the inductor 51a of each of the protective circuits 51. The grounded conductor film 42 and the dielectric film 45 compose the upper electrode, the capacitance insulating film, and the lower electrode in the capacitor 51b of the protective circuit 51.

The grounded portion of the source bias circuit 34 can also be connected to the grounded conductor film 42 through the grounding through hole 41a shown in FIGS. 5A and 5B. It is also possible to form a plurality of through holes 41a in the substrate and provide an electric connection between the grounded conductor film 42 and each of the grounded portion of the protective circuit 51 and the grounded portion of the source bias circuit 34 through the corresponding one of the grounding through hole 41a, as shown in FIG. 5C.

The through hole 41b for a capacitor in which the dielectric film 45 is filled is not limited to the circular configuration shown in FIG. 5A. It is also possible to form a through hole having a plan square or groove-like configuration as the through hole 41b for a capacitor, as shown in FIG. 5D, and configuration as the though hole 41b and the dielectric film 45 of order of 100 nm or 1 μm for a capacitor, as shown in FIG. SE and FIG. 5F.

The second embodiment is characterized in that the circuit constants of elements composing the protective circuits 51 in each of which an inductor 51a and a capacitor 51b are connected in parallel are set such that the impedance of the protective circuit 51 becomes infinite at the operating frequency of the RF device, i.e., that the protective circuit 51 is in an open state at the frequency of the RF signal inputted to the FET 11.

A description will be given herein below to conditions under which the impedance of each of the protective circuits 51 becomes infinite at the operating frequency of the RF device.

The impedance Zin of the protective circuit 51 is represented by Numerical Expression 1 shown below where the operating frequency of the FET 11 is f, the inductance value of the inductor 51a is L, and the capacitance value of the capacitor 51b is C.

$$Zin = \frac{j2 π fL}{1 - {( 2 π f )}^{2} LC} \qquad Numerical Expression 1$$

From Numerical Expression 1, conditions under which the impedance Zin of the protective circuit 51 becomes infinite are derived, which are represented by Numerical Expression 2 shown below.

$$f = \frac{1}{2 π \sqrt{LC}} \qquad Numerical Expression 2$$

Thus, the protective circuit 51 according to the second embodiment can be constructed such that the impedance becomes infinite at the operating frequency of the FET 11 by adjusting the inductance value L of the inductor 51a and the capacitance value C of the capacitor 51b.

Specifically, since the inductor 51a is formed as a short-circuited conductor line, if the length, guide wavelength, and characteristic impedance of the conductor line are designated by 1, λg, and Z₀, the inductance value L of the inductor 51a at the operating frequency f is represented by Numerical Expression 3 shown below.

$$L = \frac{{Z}_{0} tan ( 2 π l / {λ}_{g} )}{2 π f} \qquad Numerical Expression 3$$

From Numerical Expressions 2 and 3, the length L of the conductor line with which the impedance of the protective circuit 51 becomes infinite is derived, which is represented by Numerical Expression 4 shown below.

$$l = \frac{{λ}_{g}}{2 π} {tan}^{- 1} ( \frac{1}{2 π {fZ}_{0} C} ) \qquad Numerical Expression 4$$

The characteristic impedance Z₀ of the inductor composed of the conductor line is determined by the width of the conductor line. If the capacitance value C of the capacitor 51b is determined at the specified operating frequency f, therefore, the protective circuit 51 which is open to an input signal at a specified frequency can be implemented by adjusting the length and width of the conductor line.

Table 1 shows an example of the protective circuit 51 fabricated under the foregoing conditions.

TABLE 1

| Substrate | | |
|---|---|---|
| Material | Gallium Arsenide (GaAs) | |
| Thickness | 100 μm | |
| Protective Circuit | | |
| Occupied Area | 40 × 200 | μm² or Less |
| Inductor | | |
| Width of Conductor Line | 20 | μm |
| Length of Conductor Line | 200 | μm |
| Capacitor | | |
| Capacitance Value | 0.15 | pF |
| Occupied Area | 20 × 20 | μm² |
| Operating Frequency | 24 | GHz |

As shown in Table 1, if the operating frequency is 24 GHz and the capacitance value of the capacitor 51b is set to 0.15 pF, it is appropriate to construct the inductor 51a by using a conductor line having a length of about 200 μm and a width of about 20 μm. At this time, the area occupied by the capacitor 51b becomes about 20×20 μm² and the area occupied by the protective circuit 51 becomes 40×200 μm² or less.

For the impedance of the protective circuit to become infinite at the operating frequency in the first embodiment, it is necessary to adjust the length of the conductor line to correspond to an integral multiple of the quarter wavelength of the operating frequency so that the area occupied by the protective circuit is increased. By contrast, the protective circuit 51 according to the second embodiment is composed of the inductance 51a and the capacitor 51b connected in parallel to each other. This allows the impedance of the protective circuit 51 occupying an area smaller than in the first embodiment to become infinite at the operating frequency.

Thus, if the conductor line is used for the inductor 51a, the inductance value can be set to a specified value easily and reliably by adjusting the length of the line. This allows the impedance of the protective circuit 51 to become infinite at the operating frequency of the FET 11 without hindering the scaling down of the RF circuit.

In a structure using a diode for the protective circuit as used conventionally, by contrast, the parasitic inductance and parasitic capacitance of the diode vary with the bias voltage so that the values of L and C in Numerical Expression 1 change with the bias voltage to change the impedance Zin of the protective circuit.

A specific description will be given herein below to the operation of the RF circuit according to the second embodiment.

If an RF signal at a specified frequency is inputted to the input terminal 21, it is inputted to the FET 11 via the input matching circuit 31 without flowing to the ground since the protective circuit 51 connected to the gate is in a state open at the frequency of the RF signal. The RF signal inputted to the FET 11 is outputted to the output terminal 22 via the output matching circuit 32. Since the impedance of the protective circuit 51 does not suffer a deviation resulting from a voltage variation, it is possible to match the input impedance and output impedance of the FET 11 by means of the input matching circuit 31 and the output matching circuit 32.

If a pulsative surge flows into the input terminal 21, the surge flows to the ground via the inductor 51a of the protective circuit 51 connected to the gate so that the FET 11 is protected from the surge.

If a pulsative surge flows into the output terminal 22, the surge flows to the ground via the protective circuit 51 connected to the drain so that the FET 11 is protected from the surge.

Although the protective circuits 51 have been provided between the input terminal 21 and the input matching circuit 31 and between the output terminal 22 and the output matching circuit 32, the locations thereof are not limited thereto. The protective circuits 51 may also be provided between the input matching circuit 31 and the gate and between the output matching circuit and the drain. It is also possible to omit either of the protective circuit 51 closer to the input terminal 21 and the protective circuit 51 closer to the output terminal 22.

### Variation 1 of Embodiment 2

A first variation of the second embodiment according to the present invention will be described herein below with reference to the drawings.

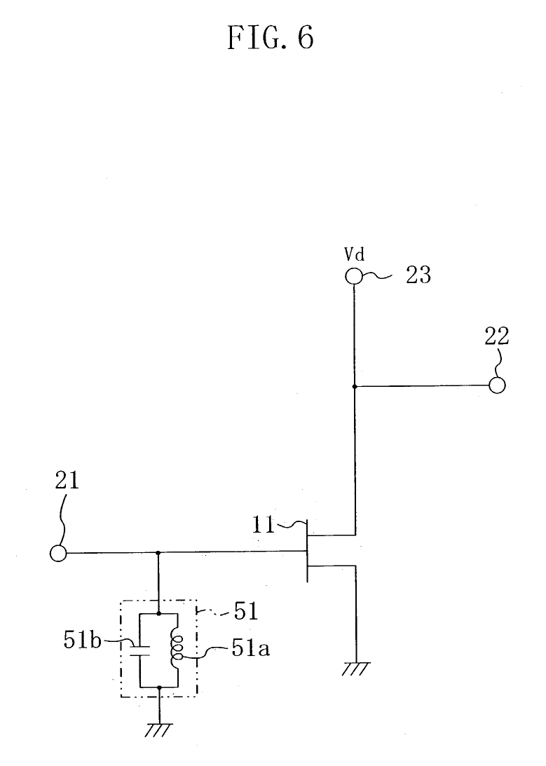

FIG. 6 shows an RF power amplifier according to the first variation of the second embodiment. As shown in FIG. 6, the first variation of the second embodiment connects the protective circuit 51 according to the second embodiment to the gate of the FET 11 and thereby uses the protective circuit 51 connected to the gate of a FET 11 to compose an RF power amplifier with a protective function.

According to the first variation, the protective circuit 51 can be used as a part of the RF amplifier element and incorporated as a chip component in a mounting board formed with a circuit for RF amplification. Since a diode element is not used for the protective circuit 51, the impedance of the protective circuit 51 is substantially constant irrespective of the voltage value of an RF signal or a surge inputted to the input terminal 21 so that a deviation from impedance matching does not occur during the operation of the RF power amplifier.

### Variation 2 of Embodiment 2

A second variation of the second embodiment according to the present invention will be described with reference to the drawings.

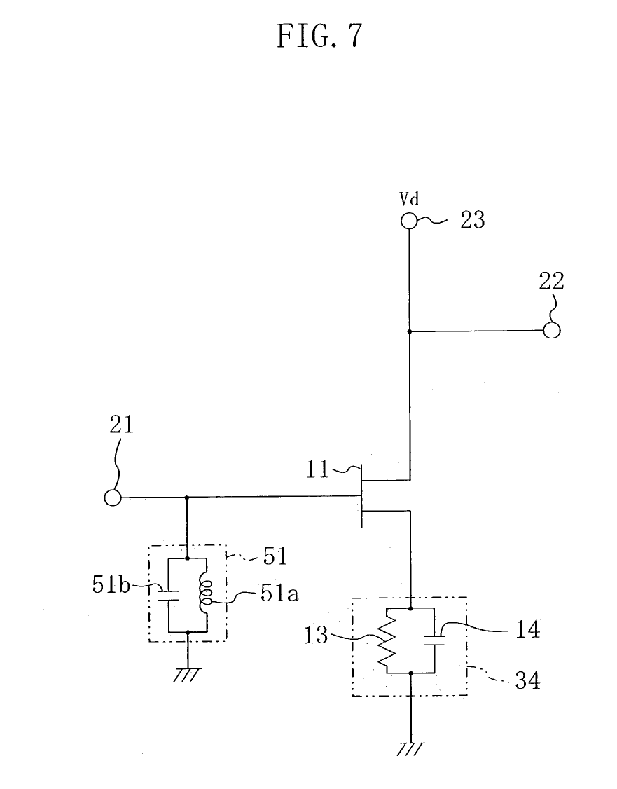

FIG. 7 shows an RF power amplifier according to the second variation of the second embodiment. The description of the same components in FIG. 7 as in FIG. 6 will be omitted by retaining the same reference numerals. As shown in FIG. 7, the second variation is different from the first variation in that the source of the FET 11 is provided with a source bias circuit 34 in which a resistor 13 and a first capacitor 14 are connected in parallel.

In the RF power amplifier according to the second variation, a specified bias voltage can be supplied from the source bias circuit 34 to the gate by adjusting the resistance value of the resistor 13. This achieves a reduction in current consumed in the RF device with the application of a negative voltage to the gate.

Referring to the drawings, a description will be given herein below to effects achieved by using the protective circuit 51 used in the second embodiment and in each of the variations thereof.

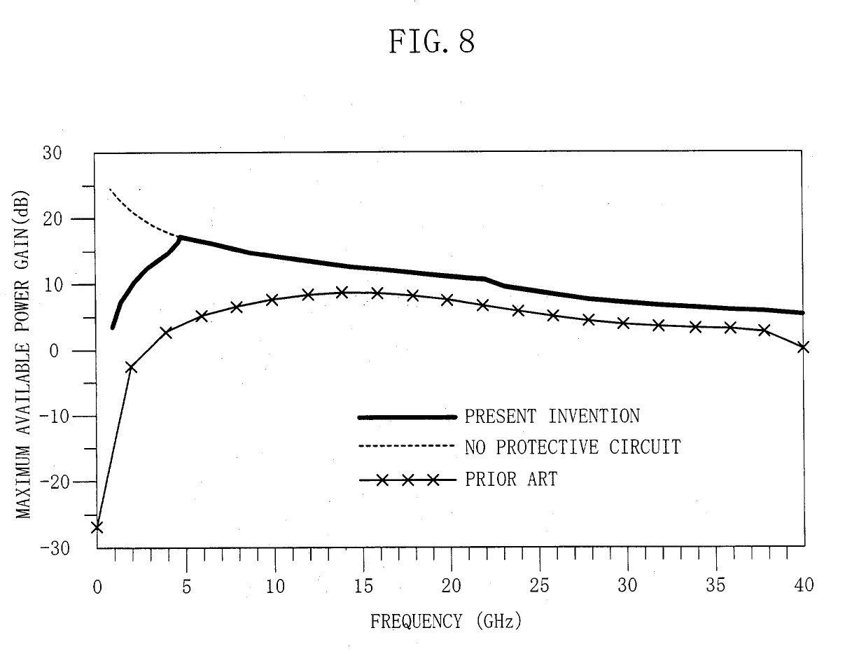

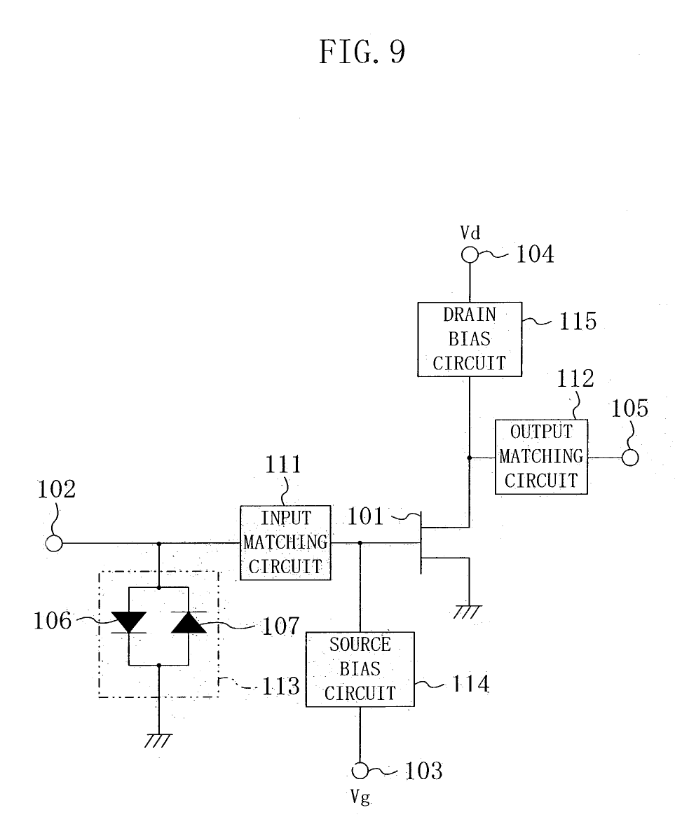

FIG. 8 shows the result of calculating the relationship between the operating frequency and maximum available power gain by simulation with the use of the RF power amplifier shown in FIG. 7.

As shown in FIG. 8, substantially the same maximum available power gain is obtainable in a high frequency band of 5 GHz or more whether the protective circuit 51 is used or not. In the conventional protective circuit using a diode, by contrast, the maximum available power gain is reduced compared with the case where the protective circuit is not used. By thus using the protective circuit 51, it is possible to protect the FET 11 from an electrostatic breakdown without causing the degradation of the RF characteristic.

Although each of the first and second embodiments and the variations thereof has described the case where the FET 11 and the passive elements composing the individual circuits are formed monolithically on the substrate made of GaAs, the present invention is not limited thereto. The passive elements composing the individual circuits may also be implemented by mounting chip components on the substrate. A material composing the substrate is not limited to GaAs. Silicon or sapphire may also be used to compose the substrate. The FET 11 may also be a MESFET or HEMT composed of another compound semiconductor such as an indium phosphide (InP) or a MOSFET composed of polysilicon.

What is claimed is:

1. A protective circuit comprising:
an inductor disposed in a line for transmitting an RF signal, the inductor having one terminal connected to the line and the other terminal grounded.

2. The protective circuit of claim 1, which is formed on a principal surface of a substrate having a grounded conductor film formed on a back surface thereof opposite to the principal surface and a through hole extending between the principal surface and the back surface, the protective circuit being connected electrically to the grounded conductor film through the through hole.

3. The protective circuit of claim 2, wherein the inductor is composed of a conductor line formed on the substrate.

4. The protective circuit of claim 3, wherein the conductor line is composed of a single-layer film made of gold or a multilayer film made of platinum and titanium stacked successively in layers.

5. A protective circuit comprising:
an inductor and a capacitor each disposed in a line for transmitting an RF signal, the inductor and the capacitor being connected in parallel to each other and having one common terminal connected to the line and the other common terminal grounded.

6. The protective circuit of claim 5, which is formed on a principal surface of a substrate having a grounded conductor film formed on a back surface thereof opposite to the principal surface and a through hole extending between the principal surface and the back surface, the protective circuit being connected electrically to the grounded conductor film through the through hole.

7. The protective circuit of claim 6, wherein the inductor is composed of a conductor line formed on the substrate.

8. The protective circuit of claim 7, wherein the conductor line is composed of a single-layer film made of gold or a multilayer film made of platinum and titanium stacked successively in layers.

9. The protective circuit of claim 8, wherein the capacitor is composed of an insulating film and upper and lower metal films having the insulating film interposed therebetween.

10. The protective circuit of claim 9, wherein each of the metal films is a single-layer film made of gold or a multilayer film made of platinum and titanium stacked successively in layers.

11. The protective circuit of claim 10, wherein the insulating film is made of a silicon nitride.

12. An RF device comprising:
a substrate;
a field effect transistor formed on a principal surface of the substrate;
a grounded conductor film formed on a back surface of the substrate opposite to the principal surface; and
a protective circuit for providing an electric connection between a gate of the field effect transistor and the grounded conductor film.

13. The RF device of claim 12, wherein the protective circuit is provided to match an input impedance of the field effect transistor.

14. The RF device of claim 12, wherein
the substrate has a through hole extending between the principal surface and back surface thereof and
the protective circuit is composed of a conductor film formed on the principal surface of the substrate and having a portion on a wall surface of the through hole connected to the grounded conductor film.

15. The RF device of claim 14, wherein the conductor film has a line portion formed on the principal surface of the substrate.

16. The RF device of claim 12, wherein
the substrate is composed of a compound semiconductor and
the field effect transistor is of Schottky junction type.

17. The RF device of claim 12, wherein an element composing the protective circuit and the field effect transistor are formed monolithically on the substrate.

18. An RF device comprising:
a substrate;
a field effect transistor formed on a principal surface of the substrate;
a grounded conductor film formed on a back surface of the substrate opposite to the principal surface; and
a protective circuit for providing an electric connection between a drain of the field effect transistor and the grounded conductor film.

19. The RF device of claim 18, wherein the protective circuit is provided to match an output impedance of the field effect transistor.

20. The RF device of claim 18, wherein
the substrate has a through hole extending between the principal surface and back surface thereof and
the protective circuit is composed of a conductor film formed on the principal surface of the substrate and having a portion on a wall surface of the through hole connected to the grounded conductor film.

21. The RF device of claim 20, wherein the conductor film has a line portion formed on the principal surface of the substrate.

22. The RF device of claim 18, wherein
the substrate is composed of a compound semiconductor and
the field effect transistor is of Schottky junction type.

23. The RF device of claim 18, wherein an element composing the protective circuit and the field effect transistor are formed monolithically on the substrate.

24. An RF device comprising:
a field effect transistor to which an RF signal is inputted; and
a protective circuit composed of an inductor and a capacitor connected in parallel to each other and having one common terminal connected to a gate of the field effect transistor and the other common terminal grounded,
the protective circuit being in a state open to a frequency of the RF signal.

25. The RF device of claim 24, wherein
the protective circuit is formed on a principal surface of a substrate having a grounded conductor film formed on a back surface thereof opposite to the principal surface and a through hole extending between the principal surface and the back surface and
the grounded common terminal of the protective circuit is connected electrically to the grounded conductor film through the through hole.

26. The RF device of claim 24, further comprising:
a bias circuit composed of a capacitor and a resistor connected in parallel to each other and having one common terminal connected to a source of the field effect transistor and the other common terminal grounded.

27. The RF device of claim 24, wherein
the protective circuit and the bias circuit are formed on a substrate having a grounded conductor film formed on a back surface of the substrate opposite to a principal surface thereof and a plurality of through holes extending between the principal surface and the back surface and
each of the grounded common terminals of the protective circuit and the bias circuit is connected electrically to the grounded conductor film through one of the plurality of through holes.

28. The RF device of claim 25, wherein
the substrate is composed of a compound semiconductor and
the field effect transistor is of Schottky junction type.

29. The RF device of claim 25, wherein an element composing the protective circuit and the field effect transistor are formed monolithically on the substrate.

30. An RF device comprising:
a field effect transistor to which an RF signal is inputted; and
a protective circuit composed of an inductor and a capacitor connected in parallel to each other and having one common terminal connected to a drain of the field effect transistor and the other common terminal grounded,
the protective circuit being in a state open to a frequency of the RF signal.

31. The RF device of claim 30, wherein
the protective circuit is formed on a principal surface of a substrate having a grounded conductor film formed on a back surface thereof opposite to the principal surface and a through hole extending between the principal surface and the back surface and
the grounded common terminal of the protective circuit is connected electrically to the grounded conductor film through the through hole.

32. The RF device of claim 30, further comprising:
a bias circuit composed of a capacitor and a resistor connected in parallel to each other and having one common terminal connected to a source of the field effect transistor and the other common terminal grounded.

33. The RF device of claim 30, wherein
the protective circuit and the bias circuit are formed on a substrate having a grounded conductor film formed on a back surface of the substrate opposite to a principal surface thereof and a plurality of through holes extending between the principal surface and the back surface and
each of the grounded common terminals of the protective circuit and the bias circuit is connected electrically to the grounded conductor film through one of the plurality of through holes.

34. The RF device of claim 31, wherein
the substrate is composed of a compound semiconductor and
the field effect transistor is of Schottky junction type.

35. The RF device of claim 31, wherein an element composing the protective circuit and the field effect transistor are formed monolithically on the substrate.
